(19) United States
(12) Patent Application Publication
(10) Pub. No.: US 2010/0226841 A1
(43) Pub. Date: Sep. 9, 2010

(54) PROCESS FOR SEPARATING OFF CARBON DIOXIDE

(75) Inventors: Robin THIELE, Speyer (DE); Susanna Voges, Ludwigshafen (DE); Jan-Martin Löning, Freinsheim (DE); Thomas Heiler, Lampertheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/716,636

(22) Filed: Mar. 3, 2010

(30) Foreign Application Priority Data
Mar. 5, 2009 (EP) 09154427.0
Mar. 23, 2009 (EP) 09155875.9

(51) Int. Cl. B01D 53/62

(52) U.S. Cl. 423/234; 423/220

(57) ABSTRACT

The present invention relates to a process for separating off carbon dioxide from gas mixtures by absorption using aqueous alkaline solutions, which comprises carrying out the absorption in a countercurrent flow apparatus in which the gas mixture which is to be worked up and the aqueous alkaline solution used are passed in countercurrent flow and wherein a discontinuous liquid phase forms in the interior of the countercurrent flow apparatus and the separation is carried out in the interior of the countercurrent flow apparatus in the presence of activated carbon, wherein the activated carbon is present in the interior of the countercurrent flow apparatus in an amount of 1 g to 2 kg of activated carbon per m³ of volume of the countercurrent flow apparatus.

The invention relates to an improved process for separating off carbon dioxide from gas mixtures by absorption using aqueous alkaline solutions.

The removal of carbon dioxide from gas mixtures in industrial processes can be of great importance for various reasons. Thus a higher CO₂ content, for example, undesirably reduces the calorific value of a gaseous fuel. In addition, CO₂, in combination with moisture which is frequently entrained in fluid streams, can lead to corrosion of pipes and fittings. In addition, separating off carbon dioxide from power station exhaust gases is gaining importance with regard to the reduction of emissions of greenhouse gases. Furthermore, in gas phase reaction processes having recycle gas recirculation in which CO₂ is formed as a byproduct, the resultant CO₂ must be continuously ejected from the process.

Various processes are known for separating off CO₂ from gas mixtures by absorption using aqueous alkaline solutions. On an industrial scale, for removal of CO₂ from fluid streams use is frequently made of aqueous solutions of bases, e.g. alkanolamines or alkali metal salt-based lyes as absorption media. On dissolution of the CO₂, ionic products form in the process from the base and the CO₂. The absorption medium can be regenerated by heating, expansion to a lower pressure or stripping, wherein the CO₂ is liberated again and/or is stripped off by means of steam. After the regeneration process, the absorption medium can be reused. Descriptions of these processes may be found, for example, in WO 2005/087349.

This process is customarily carried out in scrubbing columns such as, e.g., dumped-bed, arranged-packing and tray columns. The gas stream is treated with the absorption medium in this case, for example in a scrubbing column, in counter current flow. The gas stream is fed into the lower region of the column in this case and the absorption medium into the upper region. In the interior of the countercurrent flow apparatus a discontinuous liquid phase forms in this case. A disclosure in this context may be found in WO 2005/087349 (page 7). A co-current flow procedure is also possible in which not only the gas to be treated but also the absorption medium are applied to the top of the column. In addition to scrubbing columns, other absorbers such as membrane contactors, radial flow scrubbers, jet scrubbers, venturi scrubbers, rotary scrubbers, spray scrubbers and bubble columns are mentioned.

As scrubbing solutions, use is made of alkaline scrubbing solutions which can form carbonate and/or bicarbonate. These are frequently tertiary amines or alkali metal salt-based solvents such as NaOH or K₂CO₃. Disclosures in this context may be found in A. Kohl, R. Nielsen, Gas Purification, 5^{th} Ed., 1997 and also U.S. Pat. No. 3,907,969 and U.S. Pat. No. 4,430,312.

In gas-phase reaction processes having cycle gas recirculation, use is frequently made of solvents which do not have a vapor pressure in addition to the water vapor pressure in order not to contaminate the subsequent process stages with solvent or to poison catalysts. As solvents, use is then made of alkali metal salt-based aqueous solvents such as e.g. NaOH or K₂CO₃, as described in U.S. Pat. No. 3,907,969. Since these solvents do not exhibit carbamate formation, the absorption must be carried out at elevated temperature (80-130° C.) in order to achieve acceptable rates. The elevated temperature, however, has an adverse effect on the loading capacity of the solvent. In addition, water is discharged by evaporation, which must be countered with considerable equipment resources. Details thereon may be found in WO 03/022826 A1.

Attempts are made to accelerate as far as possible the gas absorption in the alkaline scrubbing solutions in the abovementioned processes, in particular when the scrubbing solution has a relatively low reaction rate with respect to the component which is to be separated off. Therefor, what are termed activators are fed to the alkaline scrubbing solution which can form carbonate and/or bicarbonate. These activators can be, e.g., primary and/or secondary amines which form carbamates, or vanadium pentoxide and/or boric acid. Primary and secondary amines have the advantage over tertiary amines which are used as base amines of a faster reaction rate via carbamate formation, but this has a higher reaction enthalpy compared to carbonate/bicarbonate formation, and so there are higher regeneration requirements in the industrial process. The use of vanadium pentoxide and boric acid does not lead to the formation of carbamates, but has the disadvantage that acceleration action is low.

As a preferred variant, in large-scale processes, the CO₂ is separated off in countercurrent flow apparatuses in which the gas mixture which is to be worked up and the aqueous alkaline solution used are passed in countercurrent flow, wherein, in the interior of the countercurrent flow apparatus, a discontinuous liquid phase forms. However, despite the possible addition of activators, the absorption rate is not satisfactory here which leads to a plurality of disadvantages. Thus, for a given separation task, a considerable column height is required in order to achieve the desired gas purity and in preexisting processes, in the event of increasing stringency of the profile of requirements with respect to the gas purity to be achieved, the column previously used in some cases cannot allow the requirement to be met without complex adaptation. An increase in the rate by further addition of an activator can have an adverse effect, owing to carbamate formation, on the regeneration energy required. In addition, attempts are made to improve the known processes with respect to their effectiveness, for example also with respect to the energy requirement (evaporator performance required) in a simple manner with respect to the process.

The object was therefore to find an improved process for separating off CO₂ from gas mixtures by absorption using aqueous alkaline solutions, which process prevents the abovementioned disadvantages and enables rapid and effective separation in a simple economic manner with respect to the process.

The object is achieved by a process for separating off carbon dioxide from gas mixtures by absorption using aqueous alkaline solutions, which comprises carrying out the absorption in a countercurrent flow apparatus in which the gas mixture which is to be worked up and the aqueous alkaline solution used are passed in countercurrent flow and wherein a discontinuous liquid phase forms in the interior of the countercurrent flow apparatus and the separation is carried out in the interior of the countercurrent flow apparatus in the presence of activated carbon, wherein the activated carbon is present in the interior of the countercurrent flow apparatus in an amount of 1 g to 2 kg of activated carbon per m³ of volume of the countercurrent flow apparatus.

In addition, the invention relates to preferred embodiments and also to the use of the process according to the invention for separating off carbon dioxide in processes particularly suitable therefor.

Countercurrent flow apparatuses which are suitable for the process according to the invention in this case are taken to mean those which in operation thereof in which the gas which is to be purified and the aqueous alkaline solution used are conducted in countercurrent flow form a discontinuous liquid phase. This is taken to mean that within the apparatus in the customary operating state preferably no liquid continuum forms, but interrupted liquid films or trickling films, runnels and/or drops. These are characterized by the low characteristic dimensions (film thickness, drop diameter) compared with a continuous liquid phase such as, e.g., in a stirred tank or a bubble column; these (characteristic dimensions) are a measure of the liquid-side transport paths. Customarily, such characteristic dimensions are in an order of magnitude of about 0.1 mm to 20 mm. A discontinuous liquid phase in the context of this invention is also taken to mean a liquid film which is absolutely closed over relatively large surface fractions but which has a very low film thickness. The film thickness in this case is generally less than 10 mm, preferably less than 5 mm, particularly preferably less than 3 mm.

In the case of columns preferably used, which are generally equipped with arranged packings or dumped-bed packings, the liquid phase predominantly forms strings and drops. Falling-film absorbers can also be recommended which are described, for example, in Perry's Chemical Engineer's Handbook (D. W. Green, Mc Graw-Hill). In falling-film absorbers the liquid phase comprises a liquid film. Although this is predominantly closed, nevertheless, in comparison to the gas phase, it is considered as the discontinuous phase and in the context of the present invention is taken to mean a discontinuous liquid phase since its characteristic dimension (film thickness) is typically very small. Generally, the film thickness is in a range less than 10 mm, preferably less than 5 mm, particularly less than 3 mm.

In the case of spray towers, the discontinuous liquid phase comprises drops and in the vicinity of the nozzle liquid lamellae may also occur, which are taken to mean a liquid film in the context of this invention.

Other technical apparatuses can also be used for the process according to the invention provided that, in operation thereof, the described discontinuous liquid phase is likewise formed.

The significant improvement in the process according to the invention using a countercurrent flow apparatus which has, in its interior, activated carbon in the quantitative ratio claimed would not have been expected by those skilled in the art. The addition of activated carbon and also other particles to scrubbing solutions and a resultant increase in the absorption rate are made public as a general phenomenon and also studied in more detail for stirred cells in the prior art. For instance, in DE 1544155 general indications may be found that the addition of activated carbon can lead to an improvement. More precise details of specific equipment designs are not found here.

In the publication A. A. V. M. Beenackers, W. P. M. van Swaaij; Chem. Eng. Sci. 48 (18), 3109-3139 (1993), experimental work by different authors is summarized: an acceleration of the physical absorption of O₂, CO₂ and propane in water was mentioned. In addition, an acceleration of the absorption of gases, for example in aqueous sodium carbonate, sodium sulfite and alkanolamine solutions (not mixtures) [A. K. Saha, S. S. Bandyopadhyay, A. K. Biswas; Canad. J. of Chem. Eng. 70, 193-196 (1992)] and also potash [L U Sumin, M A Younguang, Zhu Chunying, SHEN Shuhua; Chin. J. Chem. Eng. 15 (6), 842-846 (2007)] by addition of activated carbon was described. All these studies were carried out in stirred cells.

An effect of accelerated absorption was also found after addition of other particles to the scrubbing medium. Thus, e.g. in [M. V. Dagaonkar, H. J. Heeres, A. A. C. M. Beenackers, V. C. Pangarkar; Ing. Eng. Chem. Res. 41, 1496-1503 (2002)], an acceleration by the factor 2.4 on the use of fullerenes in the absorption of hydrogen in water has been observed in a stirred cell. It has been observed that hydrophobic properties of the particles used can have beneficial effects on the accelerating effect.

Only a few, sometimes contradictory statements may be found in the literature with respect to bubble columns: according to [A. Kaya, A. Schumpe, Chem. Eng. Sci. 60, 6504-6510 (2005)], the addition of activated, carbons in absorption processes in bubble columns gives no improvement. In E. Alper, in Recent Trends in Chemical Reaction Engineering (Edt. B. D. Kulkami, R. A. Mashelkar, M. N. Sharma), II, 130-140, Wiley-Eastern New Delhi, 1987] and [G. Quicker, E. Alper, W. D. Deckwer, AlChE J. 33, 871-875 (1987)], likewise no acceleration of the CO₂ absorption was found by experiments using activated carbon particles in bubble columns. In [H. Vinke, The effect of catalyst particle to bubble adhesion on the mass transfer in agitated slurry reactors, Ph. D-thesis, Municipal University of Amsterdam], in contrast, an enhancement effect is predicted by calculation in bubble columns. Also in [K. C. Ruthiya, J. v.d. Schaaf, B. F. M. Kuster, J. C. Schouten, Ind. Eng. Chem. Res. 44, 6123-6140 (2005)] with reference to [M. M. Sharma, R. A. Mashelkar, Absorption with reaction in bubble columns, Institute of Chem. Eng. Symposium Series 28, 10-21 (1968)] an enhancement effect for bubble columns is postulated.

With respect to falling-film apparatuses, to date only acceleration effects for the physical absorption of CO₂ from an exhaust gas using contaminated process water in the coking industry are known which are due to purification effects (Can. J. of Chem. Eng. 77 (5), 1999). An acceleration of a chemical absorption using alkaline scrubbing media in falling-film apparatuses is not known.

The abovementioned publications therefore do not give those skilled in the art any indications that the addition according to the invention of activated carbon in the case of the above specified countercurrent flow apparatuses, in the operation of which in the interior a discontinuous liquid phase is formed from an alkaline scrubbing solution, causes the observed beneficial effects. Apart from the fact that the publications comprise many inpart contradictory observations or postulations—for instance, different additives prove to be suitable for accelerating the absorption rate and/or are mentioned as helpful in some publications and not in others—no indications can be found in the publications that the addition according to the invention of activated carbon in these countercurrent flow apparatuses could be advantageous. There are no specific indications therefor, or even experimental studies, and those skilled in the art would also not have considered such a use in the case of these apparatuses, since here quite other processing boundary conditions prevail from, for example, in the published stirred cells.

Whereas the stirred cells concern an ideal system in which the stirrer is customarily configured in such a manner that surface turbulence (waves, vortices) are avoided, the countercurrent flow apparatuses claimed according to the invention in which in operation a discontinuous liquid phase forms in the interior exhibit local irregularities such as turbulence and liquid areas differing locally in extent. Here, depending on the apparatus used, there are finely divided liquid drops or trickling films, strings, runnels in part having liquid-wetted surface parts, in such a manner that here prediction with respect to activity of the addition by activated carbon was not predictable or expected. In a trickling film especially, e.g. the mass transport barriers described in the literature are not necessarily to be expected on account of the turbulence and constant circulation of the liquid caused by contamination with surface-active substances (cf., e.g. A. Kaya, A. Schumpe, Chem. Eng. Sci. 60 (2005) 6504-6510). The “shuttle effect” likewise described in the literature (cf. Chem. Eng. Sci. 48 (18), 1993) is likewise not expected in this form for these reasons.

In addition, the quantitative ratios of gas phase and liquid phase and the distribution of transport resistances differ. Furthermore, in the case of this design it was feared that here, owing to the conditions present, inhomogeneities or local blockages were to be expected especially owing to the solid supplied in addition for example to the arranged packings, dumped-bed packings or non-separating internals such as the liquid distributor. Those skilled in the art would therefore not have brought into consideration the addition of solid by activated carbon in the case of the industrial systems present here (countercurrent flow apparatuses used according to the invention).

Activated carbon in the context of this invention is taken to mean a particulate solid which predominantly comprises carbon and has a high-porosity structure. The internal surface area is typically 300-2000 m²/g and, in the case of activated carbon in the strict sense, the carbon content is usually greater than 90% by weight, but brown coal coke is also activated carbon in the context of this invention and here the values with respect to the surface area can be lower (approximately 300 m²/g). Graphite, as carbon, is likewise considered to be a special form of activated carbon in the context of this invention. Commercially conventional activated carbons and brown coals can be used for the process according to the invention; disclosures thereon may be found, for example, in Thieme RÖMPP Online Version 3.3 of Aug. 26, 2008 in the subject chemistry—subtopic carbochemistry. Preferably, for the process according to the invention, use is made of activated carbon which has a BET surface area of 300 to 2000 m²/g, particularly preferably 300 to 1200 m²/g. BET is a method known to those skilled in the art for measuring the internal surface area of porous materials according to Brunauer, Emmet and Teller using low-temperature nitrogen adsorption. For some applications brown-coal coke can be recommended as preferred, by which means a particularly economical process can be implemented.

The countercurrent flow apparatuses which are suitable for the process according to the invention have already been described. An essential feature in this case is that when the process for separating off the carbon dioxide is carried out a discontinuous liquid phase forms in the interior thereof. Preferably, as apparatuses, use is made here of columns having separating and non-separating internals which are operated in countercurrent flow.

Separating internals which are preferably used are dumped-bed packings or arranged packings made of metal, ceramic or plastic. Possible non-separating internals are liquid distributors, hold-down grids, support grids and liquid collectors.

Arranged packings are taken to mean separating column internals which act to intensify the mass transfer and/or heat exchange between the fluids. They increase the surface area or interfacial area between the fluids which is available for exchange processes. The arranged packings to be used according to the invention are generally selected from randomly packed dumped beds and structured packings. The column generally comprises 1 to 5, preferably 1, 2 or 3, individual arranged packings which are arranged axially spaced from one another along the longitudinal axis of the column.

Suitable dumped-bed packings are known to those skilled in the art. They can have any shapes, such as ring-shaped, saddle-shaped, wave-shaped and the like, and can have, e.g., outwardly pointing projections and/or penetration channels. The dumped-bed packings comprise, e.g., carbon steel, stainless steel, titanium, ceramic or plastic. Those which are proven are, e.g., Raschig rings and/or Pall rings and also modern high-performance dumped-bed packings such as, e.g., Superring®, Hiflow® or IMTP®.

Structured packings are known per se to those skilled in the art and are described, e.g., in Chem. -Ing. Tech. 58 (1986) No. 1, pp. 19-31 and also in Technische Rundschau Sulzer 2/1979, pp. 49ff from Gebrüder Sulzer Aktiengesellschaft in CH Winterthur. Those which are proven are, e.g., those which are marketed under the name Mellapak® (Sulzer), Flexipak® (Koch-Glitsch) or Rhombopak® (Montz).

Generally the arranged packings are held by holding appliances which are provided axially spaced from one another in the interior of the column. Preferably, the holding appliances are retaining bases or support grids. These are provided with suitable throughflows for the ascending or descending fluid. Randomly packed dumped beds can be applied directly onto such a holding base/support grid.

Between the arranged packings, generally suitable liquid distributors are provided. The liquid distributors collect the fluid flowing off from an arranged packing above and distribute it uniformly over the cross section of the arranged packing lying beneath.

Preferably, use is made of distributors which work according to the accumulation principle. The fluid drains off at an elevated static inlet pressure via narrow orifices on the underside of the distributor device. Since in the operating state the accumulation height is generally significantly greater than the maximum difference in height due to the inclined position of the column, deviations from the horizontal orientation of the distributor device do not have such a great effect as in the case of distributor systems which work according to the overflow principle. Suitable distributors are described, e.g., in EP 1386649 A1 or U.S. Pat. No. 6,294,053, or are commercially available.

The activated carbon can be added in various ways in the process according to the invention. In a preferred embodiment it can already be present suspended in the scrubbing solution which is fed to the countercurrent flow apparatus. In a further preferred embodiment the activated carbon is located in a form fixed in space within the column.

The fixing in space can be achieved, for example, by internals in the column which are provided with pockets into which the activated carbon is introduced. In addition, the activated carbon initial charge can be provided by coating arranged packings or dumped-bed packings with activated carbon powder. Preferably, the activated carbon can be installed in the form of pellets in catalyst pillows at various positions of the column; these pellets can be installed, for example, within the liquid distributor. Typically, amounts of 1 g to 2 kg of activated carbon per m³ of volume of the countercurrent flow apparatus are used, preferably 100 g to 1 kg of activated carbon per m³ of volume of the countercurrent flow apparatus. Volume of the countercurrent flow apparatus in this case is taken to mean the internal volume of the countercurrent flow apparatus. It can readily be determined by those skilled in the art; in the case of cylindrical geometry, for example, it is obtained by multiplying the area of the circle based on the internal diameter of the body by the height in the interior of the cylindrical body. The activated carbon, in the preferred variant of fixing in space, advantageously does not pass through the regeneration cycle since it is installed irremovably fixed in the column. Regeneration thereof is not really required since residual adsorption of carbon dioxide in the activated carbon does not play a role in the activity of the improved process.

In the case of addition by suspension, which can likewise be particularly recommended, the activated carbon, in the process according to the invention, is passed to the countercurrent flow apparatus, preferably in a particle size in a range of 0.1 μm to 1000 μm, particularly preferably 0.1 to 50 μm, wherein the particle size range defined here is to be taken to mean that in relatively small fractions (less than 5% by weight, based on the activated carbon used), particles in a size range outside the abovementioned range can also be present. The addition of larger particles is also possible if the mechanical stressing in the scrubbing medium circuit leads to a suitable comminution of these particles such that then a significant fraction of the activated carbon (preferably more than 0.01 kg of activated carbon per m³ of solvent, and preferably up to 20 kg of activated carbon per m³ of solvent) is in said particle size range in the countercurrent flow apparatus. Preferably, the activated carbon is fed in an amount of 0.01 to 20 kg per m³ of solvent, particularly preferably 1 to 10 kg/m³. The activated carbon should preferably be suspended in advance in water or the alkaline scrubbing medium and then added. In processes which, owing to decomposition processes, necessitate continuous ejection of scrubbing medium and also addition of fresh scrubbing medium (make-up stream), the prepared activated carbon suspension is preferably added to the make-up stream.

The aqueous alkaline solution used preferably comprises ammonia and/or amines. In the latter case, the amine is selected, e.g., from
1-(2-aminoethyl)piperazine
1-(diethylamino)ethanol
1-(dimethylamino)ethanol
1-(ethylmethylamino)ethanol
1,3-bis(aminomethyl)cyclohexane
1,3-diaminopropane
1,4-diaminobutane
1-piperazineethaneamine
2-(2-aminoethoxy)ethanol
2-(diethylamino)ethanol
2-(diisopropylamino)ethanol
2-(dimethylamino)ethanol
2-(ethylamino)ethanol
2-(ethylmethylamino)ethanol
2-(isobutylamino)ethanol
2-(methylamino)ethanol
2-(n-butylamino)ethanol
2,3-dimethylpiperazine
2,3-dimethyl-3-amino-1-butanol
2,5-dimethylpiperazine
2-amino-1-butanol
2-amino-2,3-dimethyl-1-butanol
2-amino-2,3-dimethyl-3-butanol
2-amino-2-ethyl-1-butanol
2-amino-2-methyl-1-butanol
2-amino-2-methyl-1-pentanol
2-amino-2-methyl-1-propanol
2-amino-2-methyl-3-pentanol
2-dimethylamino-2-methyl-1-propanol
2-isobutylaminoethanol
2-methylpiperazine
2-n-butylaminoethanol
2-n-pentylaminoethanol
2-n-propylaminoethanol
2-piperidineethanol
2-sec-butylaminoethanol
3-(diethylamino)-1-propanol
3-amino-1-propanol
3-amino-3-methyl-1-butanol
3-amino-3-methyl-2-butanol
3-amino-3-methyl-2-pentanol
3-diethylamino-1-propanol
3-dimethylamino-1-propanol
4-(aminoethyl)piperidine
4-(aminomethyl)piperidine
4-dimethylamino-1-butanol
4-piperidinol
5-amino-1-pentanol
aminomethylpiperazine
diethanolamine (DEA)
diethylenetriamine (DETA)
diisopropanolamine
ethylenediamine (EDA)
hexamethyleneimine
hexamethylenediamine
homopiperazine
methylaminopropylamine
monoethanolamine (MEA)
N-(2-hydroxyethyl)ethylenediamine
N-(2-hydroxypropyl)ethylenediamine
N-(2-hydroxyethyl)piperazine
N-(hydroxypropyl)piperazine
N,N,N′,N′-tetrakis(hydroxyalkyl)-1,6-hexanediamine
N,N,N′,N′-tetramethylethylenediamine
N,N,N′,N′-tetraethylethylenediamine
N,N′-bis(2-hydroxyethyl)ethylenediamine
N,N-bis(2-hydroxypropyl)amine
N,N′-di(hydroxyalkyl)piperazine
N,N′-diethylpropanediamine
N,N-diethyl-N′,N′-dimethylethylenediamine
N,N′-diisopropylethylenediamine
N,N′-dimethylethylenediamine
N,N′-dimethylpropanediamine
N-ethyldiethanolamine
N-ethylpiperazine
N-methyldiethanolamine (MDEA)
N-methylpiperazine
piperazine
piperidine
pyrrolidine
pyrrolidone
tetraethylenepentamine
tributanolamine
triethanolamine (TEA)
triethylenetetramine
triethylethylenediamine
tris(2-hydroxypropyl)amine
piperidineethanol
triethylenediamine
bis(2-dimethylaminoethyl)ether
bis(dimethylaminopropyl)amine

and mixtures thereof.

The acid gas absorption medium can also comprise at least one physical acid gas solvent. The physical acid gas solvent is selected, e.g., from sulfolane and N-methyl-2-pyrrolidone (NMP).

Preferred absorption media comprise an activator in the form of a primary or secondary amine. Preferred activators are saturated, 5- to 7-membered heterocyclic compounds having at least one NH group and optionally one further heteroatom in the ring selected from an oxygen atom and a nitrogen atom. Suitable activators are, e.g., piperazine, 2-aminobutanol, aminoethoxyethanol and methylaminopropylamine.

Preferred absorption media comprise at least one tertiary alkanolamine having 4 to 12 carbon atoms. Particularly preferred absorption media comprise at least one tertiary alkanolamine and an above defined activator.

As absorption medium, the use of amino acids or mixtures of amino acids and said amines (WO 2007134994) also comes into consideration.

The metal salts of the amino acids are also suitable as absorption media. The amino acids are selected, for example, from
beta-aminobutyric acid
1,4-piperazinediethanesulfonic acid
2-(methylamino)ethanesulfonic acid
aminoacetic acid
aminoethanesulfonic acid
2-aminoisobutyric acid
2-piperidinecarboxylic acid
aminopropionic acid
3-dimethylaminopropionic acid
3-piperidinecarboxylic acid
4-(2-hydroxyethyl)-1-piperazinebutanesulfonic acid
4-(2-hydroxyethyl)-1-piperazineethanesulfonic acid
4-(2-hydroxyethyl)piperazine-1-(2-hydroxypropane)sulfonic acid
4-(2-hydroxyethyl)piperazinepropanesulfonic acid
piperidinecarboxylic acid
glycine
L-alanine
L-isoleucine
L-leucine
L-methionine
L-valine
N-methylalanine
N-methylglycine
dimethylglycine

Particular preference is given to potassium salts of dimethylglycine or N-methylalanine.

The aqueous alkaline amine solution is introduced into the countercurrent flow apparatus preferably at a temperature of 30° C. to 70° C., particularly preferably 30° C. to 60° C. As a result of the accelerating activity of the activated carbon, alkali metal salt-based solvents such as, e.g., potash can likewise also be used at relatively low temperatures, at below 80° C., and therefore an increase in capacity can be achieved for the same column dimensions.

The process according to the invention is particularly suitable for separating off carbon dioxide from recycle gas processes in which the product is generated in a gas phase reaction in a reactor in the presence of a catalyst and CO₂ is formed in a side reaction. WO 01/98285 teaches for the production of 3,4-epoxy-1-butene that the simple use of organic solvents which have a vapor pressure is ruled out since the volatile components poison the catalyst and therefore decrease the selectivity. Therefore the use of organic activators for accelerating alkali metal salt-based solvents which are frequently used in this production process is also ruled out. Further recycle gas processes having CO₂ ejection are processes for producing ethylene oxide and vinyl acetate monomer. In contrast, the advantage of the process according to the invention is, in addition to the acceleration of the absorption, furthermore the non-existing vapor pressure of the activated carbon which is additionally added, such that here problems such as poisoning of the catalyst can be avoided.

By means of the process according to the invention, in the purification of natural gases and synthesis gases in an absorption column the solvent can advantageously be loaded with CO₂ closer to the equilibrium state. In the event of a subsequent pressure reduction, the solvent can then be depleted in CO₂ by simple flash regeneration. In addition, the process according to the invention is particularly suitable for separating off carbon dioxide from flue gases and also in the production of acetylene.

The process according to the invention offers a possibility which is effective and simple in processing terms for separating off carbon dioxide from gas mixtures, for example flue gases, by absorption in a countercurrent flow apparatus at high absorption rates. By this means, advantageously, for a certain separation task, the column height can be decreased in comparison with previously conventional processes, or a higher gas purity can be achieved for the same column height. In addition, for the same gas purity and same column height the evaporator output for regenerating the solvent can be reduced. A further advantage is that by means of the addition according to the invention of activated carbon the requirement of activator which is to be added can be decreased, which likewise leads to a reduction of the energy requirement for regeneration, since the carbamate formation is decreased. The process according to the invention therefore offers a significant improvement in absorption in the case of high service lives.

### EXAMPLE 1

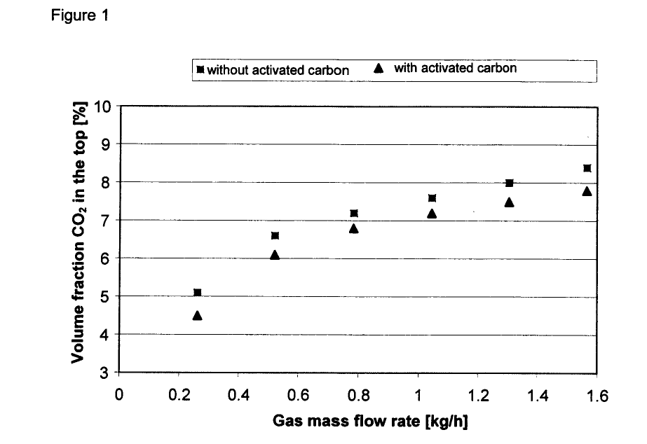

To a falling-film absorber having a diameter of 50 mm, an effective length of 400 mm and an internal tube diameter of 20 mm, 18 kg/h of aqueous amine solution comprising 60% by weight water, 35% by weight methyldiethanolamine and 5% by weight piperazine were applied to the top of the apparatus and brought into contact in countercurrent flow with gas which comprised 90% by volume nitrogen and 10% by volume CO₂. The depletion achieved in this case was determined at the top of the falling-film apparatus and is shown in FIG. 1 against the gas mass flow rate.

### EXAMPLE 2

Under otherwise identical experimental conditions as in example 1, a solvent stream of the same composition as in example 1 was fed to the falling-film apparatus, in which solvent stream activated carbon particles had been previously suspended. The activated carbon (Norit, SA Super) had a carbon content of about 90% and a BET surface area of about 1150 m³/m³ and had a median particle size of about 10 μm. The concentration in this case was 0.2% by weight (about 2.4 kg of activated carbon per m³ of solvent). The depletion of CO₂ achieved at the top of the falling-film apparatus was determined and is likewise shown in FIG. 1 against the gas mass flow rate (triangular symbols).

As may be seen in FIG. 1, an acceleration of absorption by addition of the suspended activated carbon particles was observed. Over the entire range considered with respect to the gas mass flow rate, greater depletion may be observed than without activated carbon.

1. A process for separating off carbon dioxide from gas mixtures by absorption using aqueous alkaline solutions, which comprises carrying out the absorption in a countercurrent flow apparatus in which the gas mixture which is to be worked up and the aqueous alkaline solution used are passed in countercurrent flow and wherein a discontinuous liquid phase forms in the interior of the countercurrent flow apparatus and the separation is carried out in the interior of the countercurrent flow apparatus in the presence of activated carbon, wherein the activated carbon is present in the interior of the countercurrent flow apparatus in an amount of 1 g to 2 kg of activated carbon per m³ of volume of the countercurrent flow apparatus.

2. The process according to claim 1, wherein the separation is carried out in the interior of the countercurrent flow apparatus in the presence of activated carbon particles suspended in the liquid phase, wherein the particle size of the suspended activated carbon particles is 0.1 μm to 1000 μm and the activated carbon particles in this case have a concentration of 0.01 to 20 kg of activated carbon per m³ of solvent.

3. The process according to claim 1, wherein the separation is carried out in the interior of the countercurrent flow apparatus in the presence of activated carbon which is irremovably fixed in the interior of the countercurrent flow apparatus.

4. The process according to claims 1 to 3, wherein the activated carbon used has a BET surface area of 500 to 1500 m²/g, preferably 800 to 1200 m²/g.

5. The process according to claims 1 to 4, wherein the aqueous alkaline solution used comprises primary, secondary, tertiary and/or sterically hindered amines.

6. The process according to claims 1 to 4, wherein the aqueous alkaline solution used comprises potash and/or NaOH.

7. The process according to claims 1 to 6, wherein activators are additionally fed to the aqueous alkaline solution.

8. The process according to claim 5 or 7, wherein the aqueous alkaline solution used is introduced into the countercurrent flow apparatus at a temperature of 30° C. to 70° C., preferably 30° C. to 60° C.

9. The process according to claim 6 or 7, wherein the aqueous alkaline solution used is introduced into the countercurrent flow apparatus at a temperature below 80° C.

10. The process according to claims 1 to 9, wherein, as countercurrent flow apparatus, use is made of a column comprising dumped-bed or structured packings.

11. The process according to claims 1 to 8, wherein, as countercurrent flow apparatus, use is made of a spray tower.

12. The use of the processes according to claims 1 to 11 for separating off carbon dioxide from flue gases.

13. The use of the processes according to claims 1 to 11 for separating off carbon dioxide in the production of acetylene.

14. The use of the processes according to claims 1 to 11 for separating off carbon dioxide in the production of ethylene oxide.

15. The use of the processes according to claims 1 to 11 for separating off carbon dioxide in the production of vinyl acetate monomer.

16. The use of the processes according to claims 1 to 11 for separating off carbon dioxide in the production of 3,4-epoxy-1-butene.

17. The use of the processes according to claims 1 to 11 for separating off carbon dioxide in the purification of natural gas.

18. The use of the processes according to claims 1 to 11 for separating off carbon dioxide in the purification of synthesis gas.
